(19) United States
(12) Patent Application Publication
(10) Pub. No.: US 2026/0066557 A1
(43) Pub. Date: Mar. 5, 2026

(54) Surface-Mount Technology (SMT) Component with Solderable Surface Area for Stress Relief

(71) Applicant: Arista Networks, Inc., Santa Clara, CA (US)

(72) Inventors: Samuel Thompson, San Jose, CA (US); Youngbae Park, Milpitas, CA (US)

(21) Appl. No.: 18/821,558

(22) Filed: Aug. 30, 2024

(51) Int. Cl. H01R 12/57; H01R 43/02

(52) U.S. Cl. CPC H01R 12/57; H01R 43/0256

(57) ABSTRACT

An improved surface-mount technology (SMT) component is provided. In certain embodiments, this improved SMT component can comprise a component body, a first solderable surface area disposed on a surface of the component body, where the first solderable surface area includes one or more signal leads, and a second solderable surface area disposed on the surface of the component body, where the second solderable surface area is substantially co-planar with the first solderable surface area and excludes any signal leads.

### BACKGROUND

A surface-mount technology (SMT) component is an electronic component with signal leads (e.g., pins) that can be soldered to corresponding conductive contacts (e.g., pads) on a mounting surface, such as a printed circuit board (PCB). The soldered connections between the signal leads and the conductive contacts, which allow electrical signals to pass between the SMT component and the mounting surface, are known as signal solder joints.

Several types of SMT components are subject to mechanical loads during regular use that place stress on the component's signal solder joints. For example, a connector that is mounted to a PCB using SMT and mates with a removable plug is often subject to a shearing load at the time of plug insertion and removal. Over time, these mechanical loads can damage the signal solder joints to the point where the SMT component is rendered inoperable.

### BRIEF DESCRIPTION OF THE DRAWINGS

With respect to the discussion to follow and in particular to the drawings, it is stressed that the particulars shown represent examples for purposes of illustrative discussion and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 depicts a perspective view of a conventional SMT component.

FIG. 2 depicts a side view of the conventional SMT component of FIG. 1 as mounted/soldered to a mounting surface.

FIG. 3 depicts a perspective view of an improved SMT component in accordance with certain embodiments of the present disclosure.

FIG. 4 depicts a side view of the improved SMT component of FIG. 3 as mounted/soldered to a mounting surface in accordance with certain embodiments of the present disclosure.

FIG. 5 depicts a perspective view of another improved SMT component in accordance with certain embodiments of the present disclosure.

FIG. 6 depicts a side view of another improved SMT component as mounted/soldered to a mounting surface in accordance with certain embodiments of the present disclosure.

FIG. 7 depicts a side view of another improved SMT component that is coupled with a secondary component, where both the improved SMT component and the secondary component are mounted to a mounting surface in accordance with certain embodiments of the present disclosure.

FIGS. 8A, 8B, and 8C depict a series of side views of another improved SMT component in accordance with certain embodiments of the present disclosure.

FIG. 9 depicts a workflow for mounting an improved SMT component to a mounting surface in accordance with certain embodiments of the present disclosure.

### DETAILED DESCRIPTION

In the following description, for purposes of explanation, numerous examples and details are set forth in order to provide an understanding of embodiments of the present disclosure. Particular embodiments as expressed in the claims may include some or all of the features in these examples, alone or in combination with other features described below, and may further include modifications and equivalents of the features and concepts described herein.

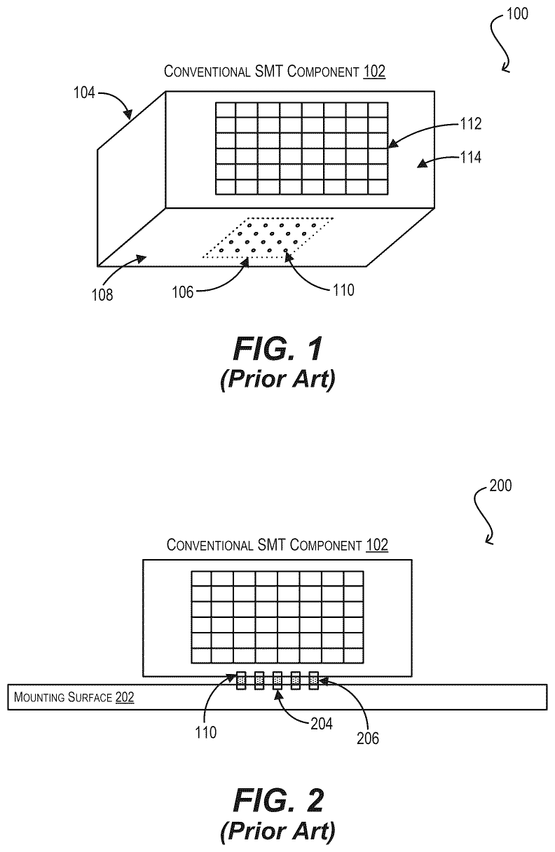

Embodiments of the present disclosure are directed to an improved SMT component that comprises one or more solderable surface areas for stress relief. To provide context for these embodiments, FIG. 1 depicts a perspective view 100 of a simplified conventional SMT component 102. As shown, conventional SMT component 102 comprises a component body or housing 104 with a solderable surface area 106 that is disposed on a first surface 108 of body 104. Solderable surface area 106 includes one or more conductive signal leads (e.g., pins or tabs) 110 that are configured to be soldered to corresponding conductive contacts on a mounting surface, thereby enabling electrical signals to be exchanged between conventional SMT component 102 and the mounting surface.

In this particular example, conventional SMT component 102 is a connector (e.g., a power connector, an input/output (I/O) connector, etc.) and thus further includes a connector interface 112 disposed on a second surface 114 of component body 104. Connector interface 112 is configured to mate with a removable plug (not shown), such as a plug that is attached to a cable or another component. Alternatively, conventional SMT component 102 may be any other type of electronic component known in the art, such as an integrated circuit (IC), an antenna, a resistor, a capacitor, etc.

FIG. 2 depicts a side view 200 of conventional SMT component 102 as mounted/soldered to a mounting surface 202. Mounting surface 202 may be, e.g., a PCB, a ceramic substrate, or the like and includes a set of conductive contacts (e.g., pads) 204 on the side of the mounting surface facing conventional SMT component 100. In this mounted arrangement, signal leads 110 of conventional SMT component 102 are connected to conductive contacts 204 of mounting surface 202 via soldered connections (i.e., signal solder joints) 206. These signal solder joints, which are typically created through a process known as reflow soldering, provide both electrical and mechanical coupling between component 102 and surface 202.

As mentioned previously, some SMT components may be subject to high mechanical loads (i.e., forces) that place stress on the signal solder joints that couple the components to their respective mounting surfaces. For example, conventional SMT component 102 of FIG. 2 may experience a high shearing load that places stress on signal solder joints 206 each time a plug is removed or inserted into the component's connector interface 112. Over time, these loads can damage signal solder joints 206 and ultimately break the electrical connection between component 102 and mounting surface 202.

One solution to this problem is to attach one or more protruding poles to surface 108 of conventional SMT component 102, where the poles are configured to be inserted into corresponding through-holes in mounting surface 202 and soldered in place (i.e., in the through-holes). This provides extra mechanical strength and rigidity to the component while it is mounted to the mounting surface and enables it to better withstand high mechanical loads. However, a significant issue with this solution is that reworking (or in other words, replacing) the SMT component becomes difficult for several reasons. First, in order to detach the SMT component from the mounting surface for rework purposes, the solder connecting the poles to the through-holes must be melted, but due to the depth of the through-holes this melting process may require large amounts of heat and/or take an extended period of time. Second, once the solder in the through-holes is melted and the SMT component is detached from the mounting surface, any residual solder left in the through-holes must be cleaned out so that the poles of the reworked SMT component can be inserted. However, this again is difficult and/or time-consuming to accomplish because of the depths of the through-holes.

Another solution is to simply fasten conventional SMT component 102 to mounting surface 202 using one or more screws. This screw-based solution has benefits such as simple assembly, superior strength, and ease of rework. However, it is possible for the fastening force of the screws to excessively compress signal solder joints 206, thereby replacing one type of stress on joints 206 (shear load) with another (compressive force). Like shear loads, such compressive force can damage and ultimately break the signal solder joints.

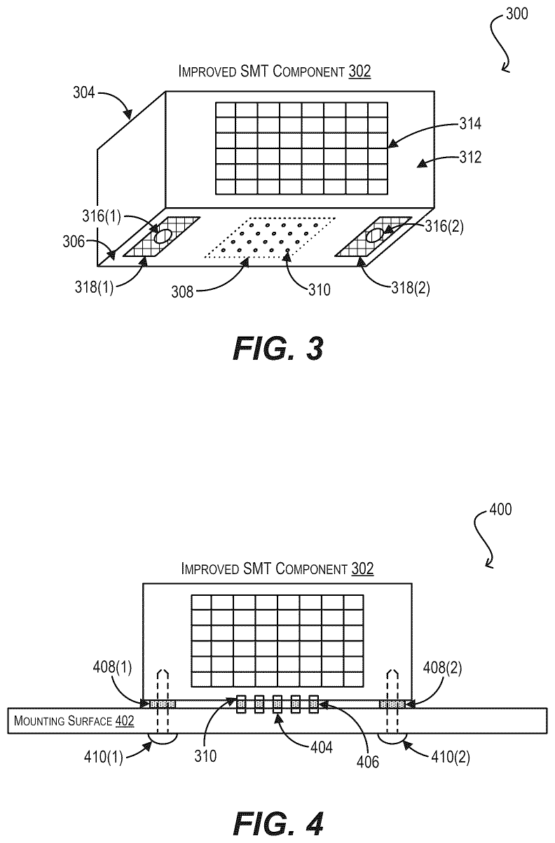

To address the foregoing and other similar problems, embodiments of the present disclosure provide an improved version of conventional SMT component 102 that includes one or more additional solderable surface areas distinct from solderable surface area 106 (referred to as stress-relief solderable surface areas), where the stress-relief solderable surface areas provide relief against the compressive force that may be applied to the component's signal solder joints by fastening screws. FIG. 3 depicts a perspective view 300 of this improved SMT component 302 according to certain embodiments. Improved SMT component 302 comprises a component body 304 with a first surface 306 having a solderable surface area 308 including a set of signal leads 310 (like solderable surface area 106 of conventional SMT component 100), as well as a second surface 312 having a connector interface 314 (like connector interface 110 of component 100). However, in addition to these elements, body 304 of component 302 includes two apertures 316(1)-(2) configured to engage screws and two stress-relief solderable surface areas 318(1)-(2) on surface 306 that are proximate to apertures 316(1)-(2) respectively. Each stress-relief solderable surface area 318 is substantially co-planar with solderable surface area 308 and does not include any signal leads. Further, in this example, each stress-relief solderable surface area 318 surrounds/encircles a corresponding aperture 316.

With this structure of improved SMT component 302 in mind, FIG. 4 depicts a side view 400 of component 302 as mounted/soldered to a mounting surface 402 according to certain embodiments. Like mounting surface 202 of FIG. 2, mounting surface 402 includes a set of conductive contacts 404 on the side of the mounting surface facing component 302. Mounting surface 402 also includes two apertures that align with apertures 316(1)-(2) of improved SMT component 302 and two solderable surface areas that align with stress-relief solderable surface areas 318(1)-(2) of component 302. Each of these solderable surface areas on mounting surface does not include any conductive contacts.

As shown in FIG. 4, signal leads 310 of improved SMT component 302 are soldered to conductive contacts 404 of mounting surface 402 via a set of signal solder joints 406, thereby establishing electrical connections between component 302 and surface 402. Further, stress-relief solderable surface areas 318(1)-(2) of improved SMT component 302 are soldered to mounting surface 402 via another set of solder joints (referred to as stress-relief solder joints) 408(1)-(2) respectively, and component body 304 is fastened to mounting surface 402 via two screws 410(1)-(2) that are screwed-in through the apertures in body 304 and surface 402 mentioned previously. Significantly, because stress-relief solder joints 408(1)-(2) are closer to these apertures than signal solder joints 406 (and thus, closer to the compressive force applied by screws 410(1)-(2)), this mounting arrangement allows stress-relief solder joints 408(1)-(2) to act as a “cushion” or “spacer” that prevents signal solder joints 406 from being excessively compressed by screws 410(1)-(2). Accordingly, this mounting arrangement, and the high-level structure of improved SMT component 302 that enables this mounting arrangement, provides most of the benefits of the screw-based solution noted above (e.g., simple assembly, superior strength, and ease of rework) while eliminating its main drawback.

It should be appreciated that improved SMT component 302 of FIG. 3 is illustrative and various modifications can be made to its design that retain (or in some cases, enhance) the foregoing benefits. For example, although improved SMT component 302 is depicted as having exactly two apertures 316(1)-(2) (to accommodate screws 410(1)-(2)) and exactly two stress-relief solderable surface areas 318(1)-(2), in alternative embodiments the component may have more or less of these apertures and/or stress-relief solderable surface areas. The specific number of apertures and stress-relief solderable surface areas implemented can depend on various factors such as the overall size of the SMT component, the size of the solderable surface area comprising the component's signal leads, and so on.

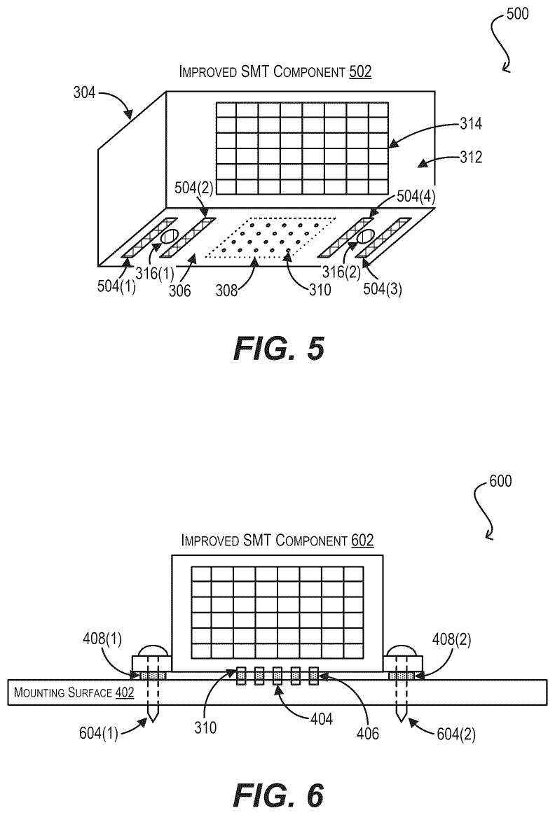

As another example, the stress-relief solderable surface areas can be arranged in different ways relative to the apertures. For instance, FIG. 5 depicts a perspective view 500 of an improved SMT component 502 that is largely similar to component 302 of FIG. 3 but includes pairs of stress-relief solderable surface areas 504(1)-(2) and 504(3)-(4) that are positioned along opposing sides of each aperture 316 (rather than surrounding/encircling each aperture).

As yet another example, although improved SMT component 302 is shown in FIG. 4 as being mounted to mounting surface 402 via screws 410(1)-(2) that are screwed-in in a “bottom-up” fashion (i.e., through the mounting surface first) and that extend into an internal cavity of the component body, in alternative embodiments these screws may be screwed-in in a “top-down” fashion (i.e., through the component first) and/or may not extend into the component body. For instance, FIG. 6 depicts a side view 600 of an improved SMT component 602 as mounted/soldered to mounting surface 402 of FIG. 4, where component 602 is fastened to surface 402 via screws 604(1)-(2) that are screwed-in top-down and protrude outward on the other side of surface 402 (rather than being screwed-in bottom-up and extending into the body of the SMT component as shown in FIG. 4).

As yet another example, in some embodiments the improved SMT component may be a connector that mates with a corresponding connector of a secondary component, where the connector of the secondary component is intended to be secured (along with the improved SMT component) to the mounting surface. For example, the improved SMT component may be a socket-type connector on a system motherboard and the secondary component may be a daughtercard with a daughtercard connector that is designed to be inserted into the socket-type connector and secured to the motherboard. In these embodiments, the improved SMT component can be soldered to the mounting surface via the signal solder joints and stress-relief solder joints mentioned previously. In addition, both the improved SMT component and the connector of the secondary component (which is inserted into the improved SMT component) can be fastened to the mounting surface using screws, where the screws pass through the apertures in the improved SMT component and corresponding apertures in the connector of the secondary component. This type of arrangement ensures that the secondary component connector is rigidly secured to both the improved SMT component and the mounting surface, while also preventing the compressive force of the screws from damaging the signal solder joints.

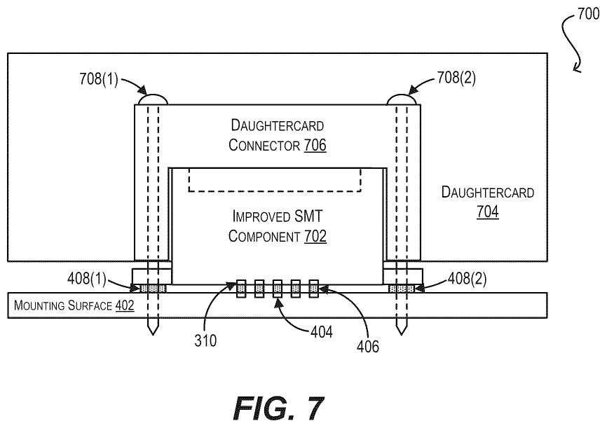

For instance, FIG. 7 depicts a side view 700 of an improved SMT component 702 and a secondary component (daughtercard) 704 that is coupled to component 702 via a daughtercard connector 706, where both component 702 and daughtercard connector 706 are secured to mounting surface 402. Like the improved SMT component shown in FIGS. 4 and 6, signal leads 310 of improved SMT component 702 are soldered to conductive contacts 404 of mounting surface 402 via a set of signal solder joints 406 and stress-relief solderable surface areas 318(1)-(2) of improved SMT component 702 are soldered to mounting surface 402 via stress-relief solder joints 408(1)-(2) respectively. In addition, improved SMT component 702 and daughtercard connector 706 are fastened together (i.e., as a coupled unit) to mounting surface 402 via two screws 708(1)-(2) that are screwed-in through aligned apertures in daughtercard connector 706, component 702, and mounting surface 402, where the apertures in improved SMT component 702 are proximate to stress-relief solder joints 408(1)-(2). Screws 708(1)-(2) prevent daughtercard connector 706 from becoming decoupled from either improved SMT component 702 or mounting surface 402. At the same time, stress-relief solder joints 408(1)-(2) prevent signal solder joints 406 from becoming excessively compressed by screws 708(1)-(2).

It should be noted that, like the embodiments described with respect to FIG. 5, the stress-relief solderable surface areas of improved SMT component 702 can be arranged in different ways relative to the apertures (screw holes) in component 702. For instance, in some embodiments, the stress-relief solderable surface areas (and thus, the stress-relief solder joints) can be positioned along opposing sides of the apertures. Further, like the embodiments described with respect to FIG. 4, screws 708(1)-(2) can be inserted in a bottom-up manner (i.e., through the mounting surface first), rather than in the top-down manner shown in FIG. 7.

As yet another example, in some embodiments each stress-relief solderable surface area of the improved SMT component may be disposed on a small removable insert that is pressed into or otherwise attached to the component body. In these embodiments, if the component needs to be detached from the mounting surface to which it is mounted, the signal solder joints can be melted while leaving the insert(s) soldered to the mounting surface (via the stress-relief solderable surface area(s)). Each insert can then be heated separately to melt the stress-relief solder joint connecting the insert's stress-relief solderable surface area to the mounting surface and the insert can subsequently be detached. The advantage of this approach is that the insert will typically have a smaller thermal mass than the SMT component body and thus will be easier to heat in order to melt the stress-relief solder joint for rework purposes.

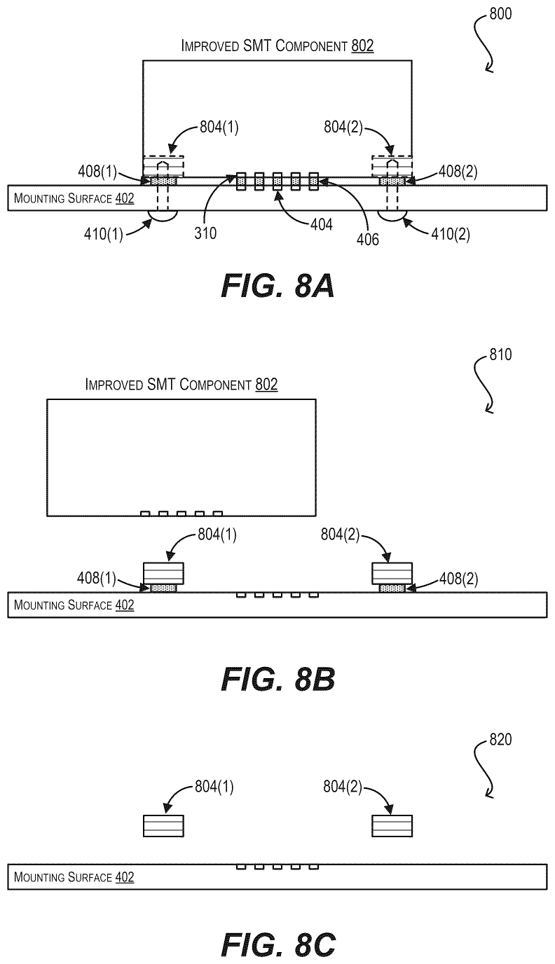

To illustrate the foregoing, FIGS. 8A, 8B, and 8C depict a series of side views 800, 810, and 820 of an improved SMT component 802 that is largely similar to component 300 of FIG. 3 but where its stress-relief solderable surface areas 318(1)-(2) are disposed on removable inserts 804(1)-(2). FIG. 8A depicts a scenario in which improved SMT component 802 is mounted/soldered to mounting surface 402 via signal solder joints 406, stress-relief solder joints 408(1)-(2), and screws 410(1)-(2). FIG. 8B depicts a scenario in which the body of SMT component 802 is detached from mounting surface 402 by melting signal solder joints 406 and removing screws 410(1)-(2), leaving only removable inserts 804(1)-(2) in place. And FIG. 8C depicts a scenario in which removable inserts 804(1)-(2) are subsequently detached from mounting surface 402 by melting stress-relief solder joints 408(1)-(2).

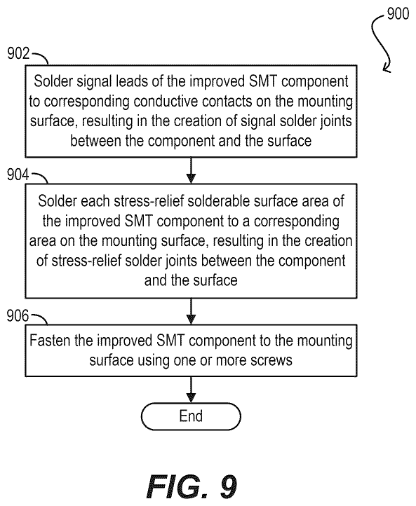

FIG. 9 depicts a high-level workflow 900 for mounting an improved SMT component (like component 302 of FIG. 3) to a mounting surface (like surface 402 of FIG. 4) in accordance with certain embodiments. Workflow 900 may be executed by, e.g., a manufacturer of a device or system that incorporates the improved SMT component. For instance, if the improved SMT component is a connector within a network device such as a switch or router, workflow 900 may be executed by the network device manufacturer as part of the device assembly process.

Starting with step 902, the signal leads of the improved SMT component can be soldered to corresponding conductive contacts on the mounting surface, resulting in the creation of signal solder joints between the component and the surface.

At step 904, each stress-relief solderable surface area of the improved SMT component can be soldered to a corresponding area on the mounting surface, resulting the creation of stress-relief solder joints between the component and the surface. In some embodiments, steps 902 and 904 may be performed together by passing the improved SMT component and the mounting surface through a reflow oven that heats all of the solderable contact areas between these the component and the surface simultaneously.

Finally, at step 906, the improved SMT component can be mechanically fastened to the mounting surface using one or more screws. As mentioned previously, each screw can be screwed into an aperture of the improved SMT component that is proximate to a stress-relief solderable surface area, thereby allowing the stress-relief solder joint connecting that area to the mounting surface to relieve the compressive force applied by the screw to the component's signal solder joints.

The above description illustrates various embodiments of the present disclosure along with examples of how aspects of these embodiments may be implemented. The above examples and embodiments should not be deemed to be the only embodiments and are presented to illustrate the flexibility and advantages of the present disclosure as defined by the following claims. For example, although certain embodiments have been described with respect to particular workflows and steps, it should be apparent to those skilled in the art that the scope of the present disclosure is not strictly limited to the described workflows and steps. Steps described as sequential may be executed in parallel, order of steps may be varied, and steps may be modified, combined, added, or omitted. As another example, although certain embodiments may have been described using a particular combination of hardware and software, it should be recognized that other combinations of hardware and software are possible, and that specific operations described as being implemented in hardware can also be implemented in software and vice versa.

The specification and drawings are, accordingly, to be regarded in an illustrative rather than restrictive sense. Other arrangements, embodiments, implementations, and equivalents will be evident to those skilled in the art and may be employed without departing from the spirit and scope of the present disclosure as set forth in the following claims.

1. A surface-mount technology (SMT) component comprising:
a component body;
a first solderable surface area disposed on a surface of the component body, the first solderable surface area including one or more signal leads; and
a second solderable surface area disposed on the surface of the component body, the second solderable surface area being substantially co-planar with the first solderable surface area and excluding any signal leads.

2. The SMT component of claim 1 wherein the component body includes an aperture configured to engage a screw.

3. The SMT component of claim 2 wherein the aperture is proximate to the second solderable surface area.

4. The SMT component of claim 2 wherein the second solderable surface area surrounds the aperture.

5. The SMT component of claim 2 wherein the SMT component is mounted to a mounting surface by:
soldering the first solderable surface area to a first surface area of the mounting surface that includes one or more conductive contacts;
soldering the second solderable surface area to a second surface area of the mounting surface that excludes any conductive contacts; and
fastening the component body to the mounting surface using a screw that is inserted into the aperture.

6. The SMT component of claim 5 wherein the soldering of the first solderable surface area to the first surface area of the mounting surface creates one or more first solder joints between the component body and the mounting surface,
wherein the soldering of the second solderable surface area to the second surface area of the mounting surface creates one or more second solder joints between the component body and the mounting surface, and
wherein the one or more second solder joints relieve stress on the one or more first solder joints caused by the fastening of the component body to the mounting surface using the screw.

7. The SMT component of claim 1 wherein the second solderable surface area is part of a removable insert that is pressed into or attached to the component body.

8. The SMT component of claim 1 wherein the SMT component is a connector that is configured to mate with a removable plug.

9. A method for mounting an SMT component to a mounting surface, the method comprising:
soldering a first solderable surface area of the SMT component to a first surface area of the mounting surface, wherein the first solderable surface area of the SMT component is disposed on a surface of the SMT component and includes one or more signal leads, and wherein the first surface area of the mounting surface includes one or more conductive contacts; and
soldering a second solderable surface area of the SMT connector to a second surface area of the mounting surface, wherein the second solderable surface area of the SMT component is disposed on the surface of the SMT component and excludes any signal leads, and wherein the second surface area of the mounting surface excludes any conductive contacts.

10. The method of claim 9 wherein the SMT component includes an aperture configured to engage a screw.

11. The method of claim 10 wherein the aperture is proximate to the second solderable surface area.

12. The method of claim 10 wherein the second solderable surface area surrounds the aperture.

13. The method of claim 10 further comprising:
fastening the SMT component to the mounting surface using a screw that is inserted into the aperture.

14. The method of claim 13 wherein the soldering of the first solderable surface area of the SMT component to the first surface area of the mounting surface creates one or more first solder joints between the SMT component and the mounting surface,
wherein the soldering of the second solderable surface area of the SMT component to the second surface area of the mounting surface creates one or more second solder joints between the SMT component and the mounting surface, and
wherein the one or more second solder joints relieve stress on the one or more first solder joints caused by the fastening of the SMT component to the mounting surface using the screw.

15. The method of claim 14 wherein the second solderable surface area is part of a removable insert that is pressed into or attached to the component body.

16. The method of claim 15 wherein the SMT component is detached from the mounting surface by:
melting the one or more first solder joints;
detaching the SMT component from the mounting surface and the removable insert;
melting the one or more second solder joints; and
detaching the removable insert from the mounting surface.

17. A surface-mount technology (SMT) component comprising:
a component body;
a first solderable surface area disposed on a surface of the component body, the first solderable surface area including one or more signal leads;
a second solderable surface area disposed on the surface of the component body, the second solderable surface area excluding any signal leads; and
an aperture in the component body configured to engage a screw.

18. The SMT component of claim 17 wherein soldering of the first solderable surface area to a first surface area of a mounting surface creates one or more first solder joints between the component body and the mounting surface,
wherein soldering of the second solderable surface area to the second surface area of the mounting surface creates one or more second solder joints between the component body and the mounting surface, and
wherein the one or more second solder joints relieve stress on the one or more first solder joints caused by fastening of the component body to the mounting surface using the screw.

19. The SMT component of claim 17 wherein the second solderable surface area is closer to the aperture than the first solderable surface area.

20. The SMT component of claim 17 further comprising a connector configured to engage a corresponding connector of a secondary component, wherein both the SMT component and the secondary component are mounted to a mounting surface by:
inserting the corresponding connector of the secondary component into the connector of the SMT component;
soldering the first solderable surface area to a first surface area of the mounting surface that includes one or more conductive contacts;
soldering the second solderable surface area to a second surface area of the mounting surface that excludes any conductive contacts; and
fastening the component body and the corresponding connector of the secondary component to the mounting surface using a screw, wherein the screw is inserted into the aperture of the SMT component and into a corresponding aperture of the corresponding connector of the secondary component.
